(19) United States
(12) Patent Application Publication
(10) Pub. No.: US 2005/0240519 A1
(43) Pub. Date: Oct. 27, 2005

(54) System and method for automated commerce directed towards minority suppliers

(76) Inventors: Curtis E. Aiken SR., Pittsburgh, PA (US); Jason Matthews, Pittsburgh, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/832,119

(22) Filed: Apr. 26, 2004

(51) Int. Cl. G06F 17/60

(52) U.S. Cl. 705/39

(57) ABSTRACT

An on-line interactive electronic commerce system for the purchase and sale of goods and/or services between purchasers and qualified suppliers. Suppliers are qualified to participate by submitting information and registering with the host site. Some suppliers must present a recognized certification to be classified as a minority or women-owned enterprise. Purchasers post a request for quote or request for purchase to the host site and qualified suppliers respond by bidding on the contract. Alternatively, the purchaser can order products directly from a catalog established by qualified suppliers and accessible through the host site. Suppliers can bid on projects/contracts through a reverse auction process, and the purchaser awards a contract to a bidding supplier and issues an appropriate purchase order. After the winning supplier fulfills the term of the purchase order, an invoice is transmitted to the purchaser and payment is rendered, all via the host site. The host site presents a report summarizing each completed transaction, and can provide a statistical analysis of the total transaction.

### BACKGROUND OF THE INVENTION

1. Field of the Invention

The present invention relates generally to conducting electronic commerce or on-line contracting services and, more particularly, to a system and method for conducting commerce among various purchasers and certified minority or women-owned supplier companies.

2. Description of the Prior Art

Various systems and processes are available for entities to notify potential suppliers of contracts for goods and services that need to be fulfilled. These contracts can be as simple as fulfilling office supply contracts or as complex as general contracting arrangements for the construction of office buildings, highways and other government and/or private contracting ventures. In each of these situations, it has become desirable as an important public policy initiative to direct contracting services and supplier services to identified minority bidders. Minority bidders are generally defined as Minority and Women-Owned businesses as determined by each customer. These minority contractors and suppliers can be certified in various numbers of ways such as obtaining a certification through NMSDC, the National Minority Supplier Development Council. Minority contractors also include women-owned business entities.

Many systems and processes have been developed to enable buyers and sellers to enter into contracts over a global telecommunications network such as the Internet. Purchasers can buy directly from an identified supplier through on-line catalogs, for example, or bid on projects in a traditional auction through dedicated websites like “eBay” where interested buyers can search for and purchase specialty items from a myriad of sellers.

In a typical auction, such as on “eBay,” potential buyers bid against other buyers, increasing the price each time, in order to purchase a particular object from a seller at the best possible maximum price for the seller. There are other mechanisms for suppliers to provide products to purchasers, and are generally referred to as a reverse auction. In this instance, suppliers submit bids generally lowering the bid price each time for the benefit of the buyer, so as to purchase goods or services at the best possible minimum price.

Each of these situations generally involve conventional buyers and sellers purchasing products in an open common market without the need to specifically identify or qualify particular buyers and sellers, other than providing basic financial information to effect the sale. Although specialty buyers may be identified for the purchase of particular products through a seller's website, there are situations where conventional contracting arrangements are not sufficient in performing all the actions necessary between particular buyers and sellers. For example, in certain contracting situations, government or public policy considerations generally require or request that a certain percentage of contracts be awarded to what are referred to as “minority” or “women-owned” business enterprises. It would be quite beneficial to such suppliers if there were an integrated process providing access to specific contracts for which they are qualified. Moreover, when issuing contracts and requesting minority or women-owned business participation, it is not always easy for the purchaser or general contractor to verify that potential subcontractors and/or suppliers qualify as such a business entity.

Moreover, government agencies, as well as social organizations generally, request that purchasers or contractors issue periodic reports delineating the volume of minority contracts that a particular enterprise has awarded. It is also desired that these reports provide a verifiable dollar amount that has been paid to minority and women-owned businesses. This requires that purchasers and general contractors maintain meticulous records so that such reporting can be audited and verified. Occasionally a governnent entity will not allow a general contractor to participate in municipal contracts unless and until it is verified that the general contractor itself is a minority or women-owned entity or has a record of providing for minority and women-owned enterprise participation at the subcontractor level. Such participation may also include the direct purchase of commodity goods and services directly from such qualified suppliers, such as office suppliers, for example, through the qualified suppliers regularly published catalog or building maintenance services.

In each purchasing or contracting situation, it is also desirable that the purchaser can receive bids or browse catalogs of minority-qualified suppliers that fit the bidding criteria. For example, if a concrete supplier were needed, only such contractors and/or subcontractors would be permitted to bid. Thus, for example, the purchaser can be comfortable that entities bidding on a particular project are not only qualified as minority or women-owned business entities, but also have expertise in concrete. Additionally, when a purchaser desires to purchase office supplies or other commodities from an e-catalog, the purchaser can perform a single search and be presented a catalog for general office supplies and not for other products and services, such as building maintenance or landscaping services. In this way, the purchaser can more efficiently order such goods and services.

Under conventional contracting/purchasing scenarios, the purchaser must either individually contact qualified suppliers and request them to bid, or accept bids from all prospective suppliers. In the latter case, the purchaser/contractor must rely on the statements made by the suppliers and may not reach or contact an actual qualified minority or women-owned business entity.

It would be advantageous if a purchaser/contractor could eliminate the need to investigate the credentials of reputed minority or women-owned business entities when trying to advance these worthy goals. By being assured that bidders qualify as these types of business entities, the purchaser can concentrate more on its business operations. Alternatively, qualified suppliers do not have to establish their credentials each time they want to bid on a contract or respond to a request for proposal/quote.

What is needed then is a process and method whereby contractors and purchasers can be assured that they are dealing with verified minority and women-owned businesses. It is therefore an object of the present invention to provide an integrated telecommunications network, such as a host site operating on the Internet, whereby minority and women-owned businesses can bid on contracts and provide goods and services to purchasers such as general contractors.

It is a further object of the present invention to provide a system and method whereby purchasers are assured that the suppliers are qualified as minority and women-owned businesses.

It is a still further object of the present invention to provide a system for generating statistical or other reports for purchasers detailing the contracts that have been awarded to qualified minority and women-owned businesses.

### SUMMARY OF THE INVENTION

The present invention provides an electronic commerce system comprising a host location having means for registering suppliers of goods or services according to predetermined supplier qualification criteria with the host location. One or more purchasers of goods or services are also registered, wherein the purchaser may establish minimum terms and conditions for purchasing goods or services within the host location. Means for the suppliers to submit bids to the purchaser are provided, and the purchase contract or purchase order is issued or awarded to a winning supplier. Means are provided for issuing an invoice from the winning supplier to the purchaser such that the purchaser can compensate the winning supplier via the host location to provide a completed transaction. The host site is then enabled to provide a report identifying the completed transaction between the purchaser and the winning supplier. Preferably the host site is a dedicated website on the Internet.

A method of completing a commercial transaction over a telecommunications network between a purchaser and a qualified supplier comprises the steps of providing a host site on the telecommunications network and registering a plurality of qualified suppliers according to one or more predetermined criteria. A request is posted on the host site from the purchaser for the purchase of goods and/or services from the registered qualified suppliers. One or more qualified suppliers then submit bids to the host site for supplying the goods and/or services to the purchaser. The purchaser selects a winning supplier from the submitted bids and the purchaser issues a purchase order to the winning supplier through the host site. The winning supplier performs under the purchase order and issues an invoice to the purchaser, also through the host site, and the purchaser compensates the winning supplier.

The host site can issue a report identifying a completed commercial transaction between the purchaser and the winning supplier. Since all transactions occur through an integrated host site, the purchaser and qualified winning supplier are relieved from tedious paperwork and tracking requirements, and the host site can provide accurate statistical reports identifying contract activities for qualified suppliers such as minority or women-owned business entities.

### BRIEF DESCRIPTION OF THE DRAWINGS

Various other objects, features and advantages of the present invention will become readily apparent by reading the following description in conjunction with the drawings, which are shown by way of example only, wherein:

FIG. 1 shows a flow chart of the minority supplier process of the present invention;

FIG. 2 is a screen representation of a registration form for suppliers;

FIG. 3 is a representation of a registration form/screen for purchasers/buyers;

FIG. 4 is a screen representation of a manage auction for purchasers;

FIG. 5 is a representation of a request for quote to be proposed by a purchaser;

FIG. 6 is a screen representation of a reverse auction screen;

FIG. 7 is a screen representation of an invoice generated by the host site;

FIG. 8 is a representation of a purchase order generated by the host site; and

FIG. 9 is a representation of a report generated by the host site.

### DESCRIPTION OF THE PREFERRED EMBODIMENTS

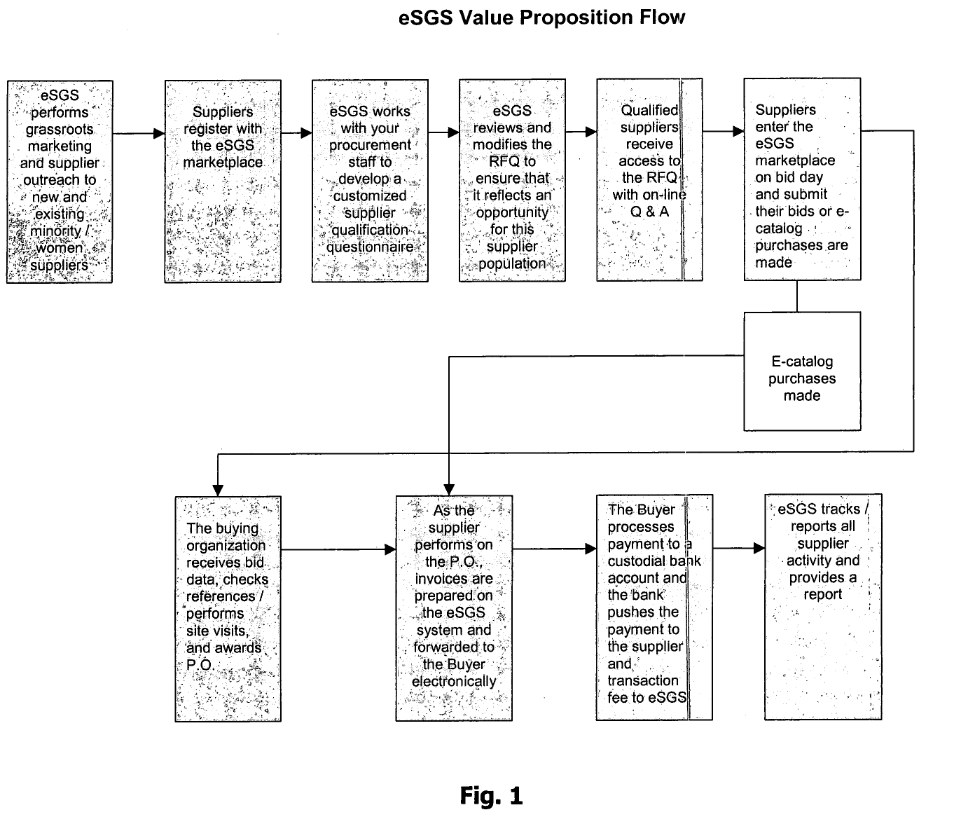

Referring now to the drawings in detail, there is shown in FIG. 1 a flow chart for a system and method for completing commercial transactions over a telecommunications network, such as the Internet, between qualified suppliers and purchaser/contractors. A qualified supplier is generally defined as a minority or women-owned enterprise, or any business entity to which it is desired to direct contracts and supply agreements. To be a qualified supplier, each supplier must satisfy the particular criteria to be so certified as a minority or women-owned business, for example. As shown in the flow chart of FIG. 1, a host site is established on a global telecommunications network, such as the Internet or worldwide web, and qualified suppliers are contacted and urged to register on the host site for the transaction of business.

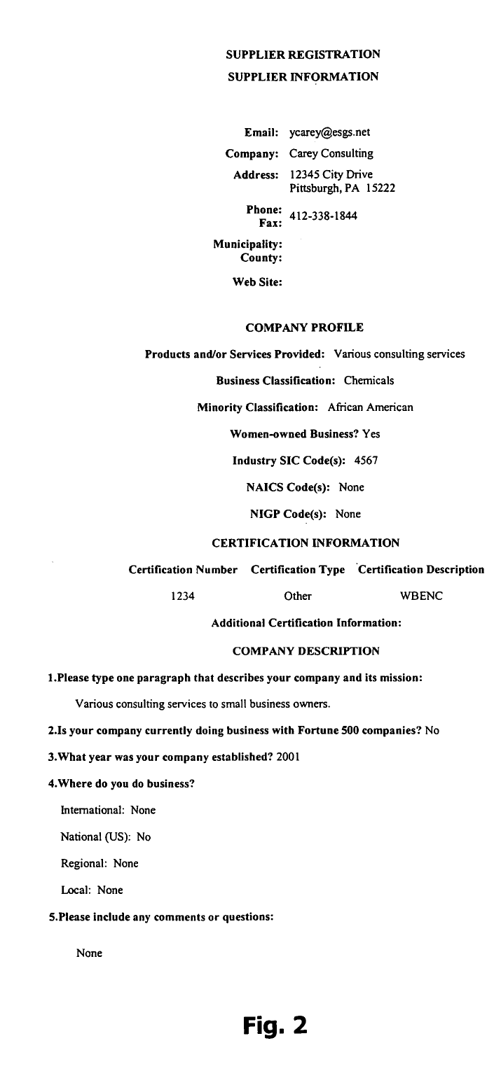

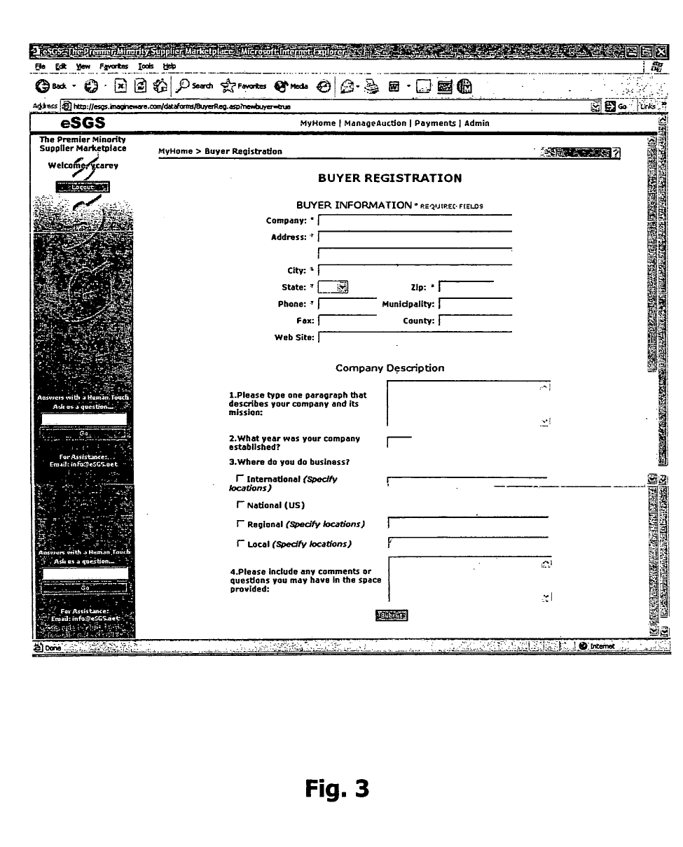

The qualified suppliers preferably register with the host site by using the registration screen shown in FIG. 2. Although many different informational boxes are provided for the input of qualified supplier information, it will be appreciated by those skilled in the art that more, less or different business identifiers may be used. For example, the qualified supplier may enter its name, address, type of corporation, and certification information as to how they qualify as a minority and/or a women-owned business. As set forth hereinafter, the qualified supplier may also post a product catalog which lists commodity-type goods and services from which purchasers may order items directly. Also, more or less information may be provided or may be requested by particular purchasers when posting or establishing a contract for which bids are solicited, as will be more fully explained hereinafter. In the example show in FIG. 2, Carey Consulting is registering to provide various consulting services, and may indicate an expertise in chemicals. In this example, Carey Consulting qualifies as both a minority and a women-owned business. As shown in FIG. 3, purchasers or buyers also register by inputting company identity information such as name, address, phone/fax numbers, website and other descriptive information, if desired.

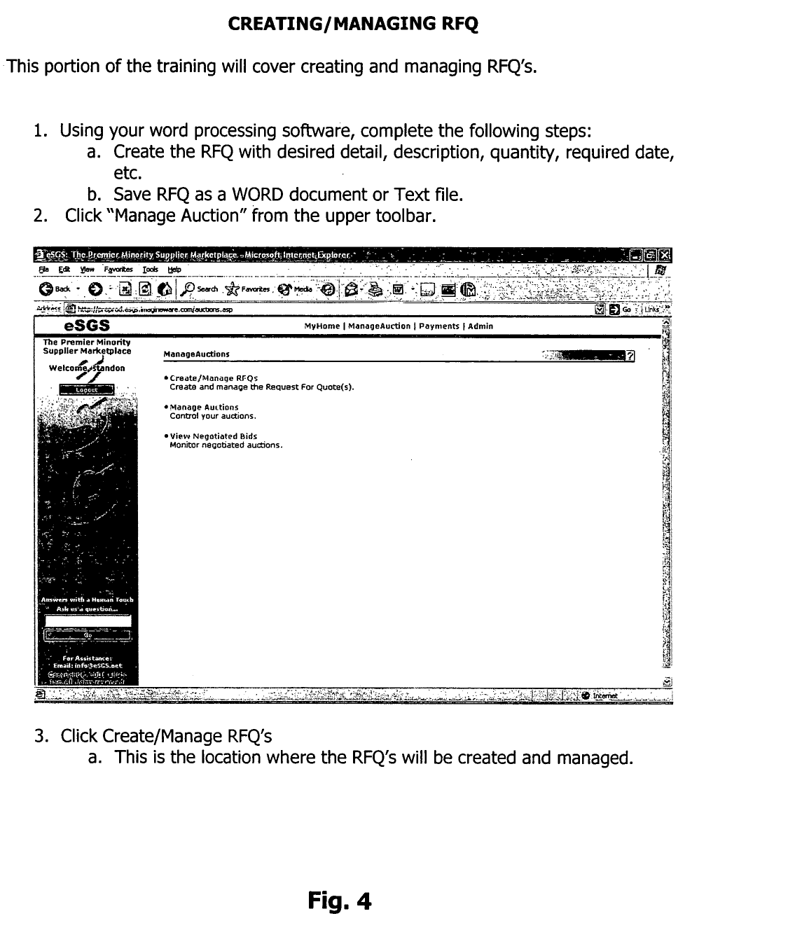

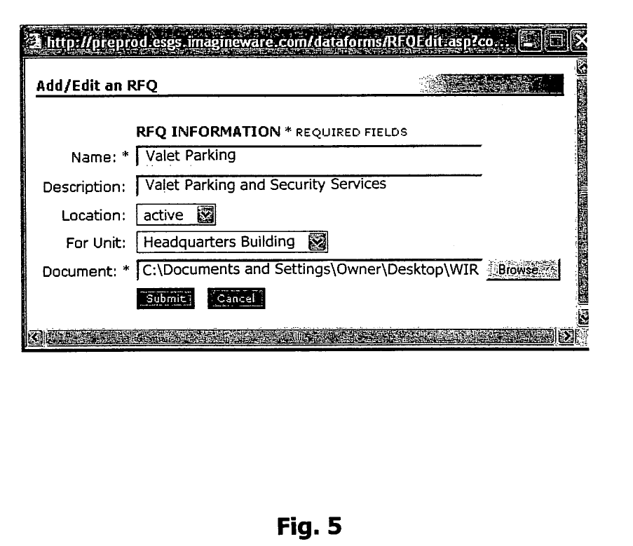

Just as suppliers have been qualified, purchasers are subscribers to the system in order to be able to post requests for quote (RFQ) for qualified suppliers to bid on, or to issue requests for proposal (RFP) to which qualified suppliers may reply. The purchasers can then initiate a new project by accessing a “manage auction” screen as represented by FIG. 4. By checking on “create/manage RFQs,” the purchaser can input terms and conditions for the new project. A purchaser inputs the necessary information that it needs in order for qualified suppliers to bid on projects, as shown in FIG. 5. As shown in FIG. 5, for example, the purchaser or general contractor enters information regarding valet parking and security services. If desired, a more detailed RFQ can be inputted as a document in the lower portion of the bid information screen. For example, the purchaser may indicate the size of the parking facility, the number of parking spaces available, whether the facility is an indoor garage, the average volume of vehicles using the facility each day, and so on. This information can help interested suppliers determine their expected costs by calculating how many attendants may be needed for parking and/or security personnel to help them establish their minimum bid price so as to determine the potential profitability in bidding on this RFQ. Although FIG. 5 is representative of information to be inserted by a purchaser soliciting bids for valet parking and security services, it will be appreciated by those skilled in the art that other pertinent information may be inputted based on the type of work to be performed under the RFQ.

After the RFQ is created, there is an option to break the RFQ out into several lots. Breaking the RFQ up into smaller sections or lots offers increased participation by smaller minority or women-owned corporations.

After the RFQ is posted, qualified suppliers that are approved by the purchaser can receive access to the RFQ based on the information that they have provided to the host site regarding their qualifications as to the type of business in which they are engaged. In this example, based on the suppliers' business profile, qualified business entities such as Carey Consulting receive an e-mail or other notification from the host site informing the entity of the RFQ, and inviting that supplier to bid on the RFQ on a designated bid date. Thus, the host site directs RFQs to only those qualified suppliers who have expertise or meet the qualifications set forth by the purchaser in the RFQ for fulfilling the terms of the contract.

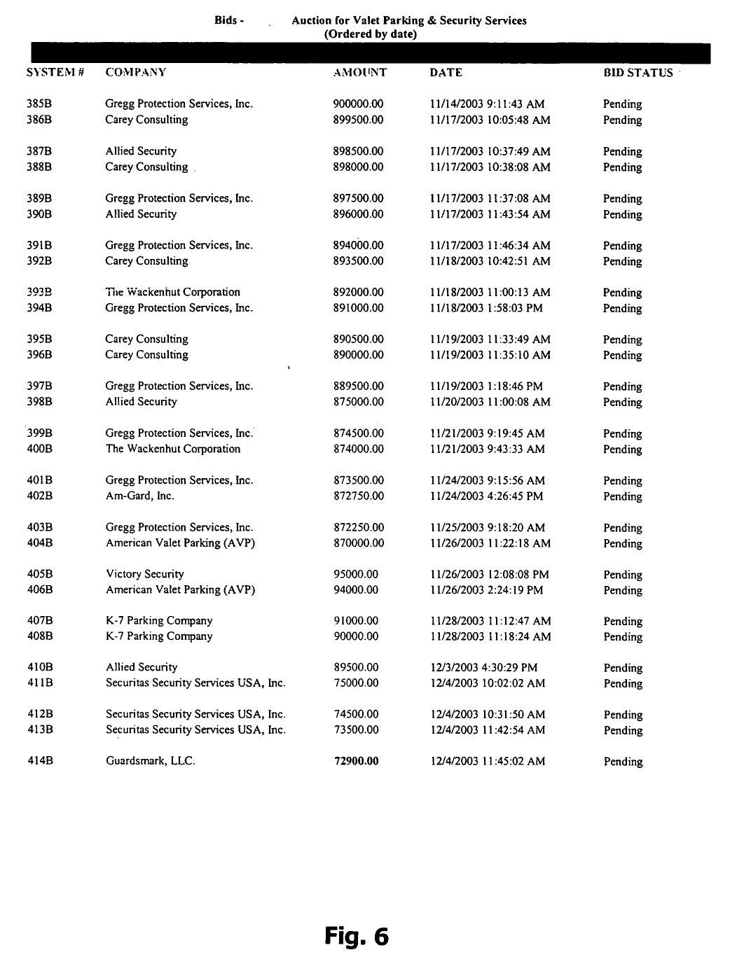

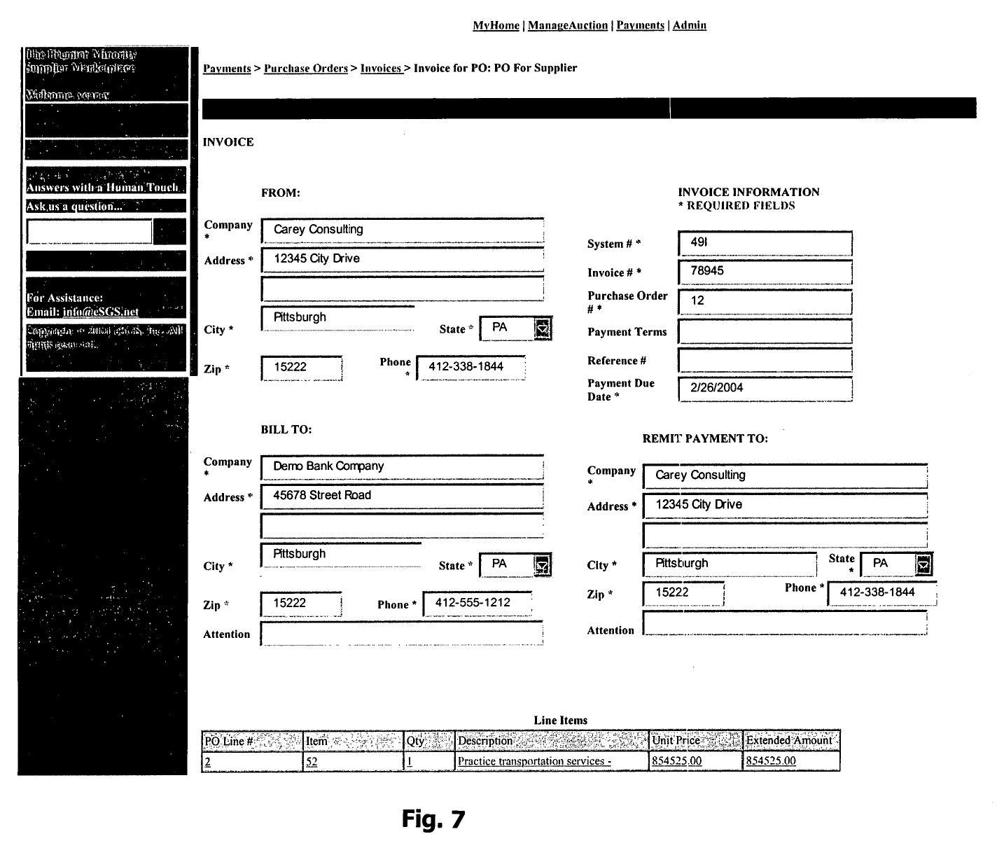

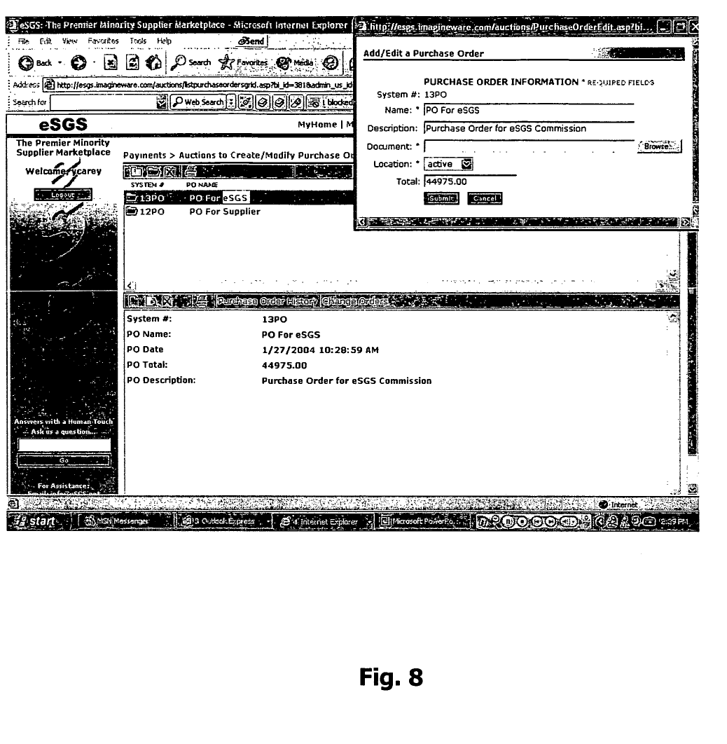

After all interested and qualified suppliers have registered to bid on the RFQ, the purchaser approves which suppliers they wish to enter the host site on the day designated for the reverse auction and submit their bids to the purchaser for fulfilling the contract. According to the terms of the Web Site Terms & Conditions, suppliers will have access to the bid price of other qualified suppliers, but not access to the suppliers' name that submitted the price. Preferably, the purchaser sets a maximum allowable bid that the qualified suppliers may submit and thereby encourages them to submit their best offer as soon as possible. Approved qualified suppliers can then progressively submit lower bids on projects in order to provide the lowest price to the purchaser until the end of the auction. This is shown, for example, in FIG. 6. As can be seen therein, a plurality of qualified suppliers successively post lower bids. In this example, the last, low price is visible to all suppliers, so as to continually drive down the price in this reverse auction process, until the time to bid expires, and the lowest bidder becomes the winning supplier.

Alternatively, the purchasers may want to purchase commodity goods and/or services directly from a particular qualified supplier and not through a reverse auction process. Qualified-suppliers can submit their catalog of products to the host site, commonly referred to as an “e-catalog.” The host site provides a central location for qualified suppliers to post their e-catalogs. When a purchaser desires to buy commodities, such as office supplies and the like, the purchaser can directly access a qualified supplier's e-catalog and submit an order for these items. The location on the integrated host site allows purchasers to browse and/or search the posted e-catalogs for particular items and to compare prices. The search can be narrowed initially by the purchaser submitting a request for office supplies, for example, and only those e-catalogs posted by qualified suppliers who have identified their type of corporation in this way will be presented or outputted to the purchasers via the host site.

In either event, either at the end of a reverse auction or after a purchaser submits an order through a qualified supplier's e-catalog, the host site generates a purchase order reflecting the final bid terms or the delivery terms from the e-catalog. Since the purchaser order is generated based on the terms of the RFQ, RFP or e-catalog, and is generated by the host site, the host site maintains a record of the transactions occurring between a purchaser and a winning supplier. As the winning supplier performs under the purchase order, invoices are prepared by the host site which invoices are submitted to the purchaser on behalf of the winning supplier. The buyer or purchaser/contractor then processes payment to or utilizes the ACH (Automated Clearing House) feature where the bank transmits payment directly to the winning supplier. The host site may charge a fee for this process, which fee is automatically deducted from the fee paid to the winning supplier and may be a percentage of the payment processed through the ACH.

Since the host site controls the issuance of the purchase order and the invoices, as well as preferably the payment transaction between the purchaser and the winning supplier, the host site is able to track and provide reports regarding all qualified supplier activity, as well as contracts entered into by purchasers/contractors and can provide a report to both parties. In this way, detailed and accurate records and statistical information can be maintained by the host site in the event that purchasers need to establish the level of minority and women-owned business contracting. Purchasers can be provided data indicating the number of minority and women-owned business entities which have been awarded contracts, the dollar amount of such contracts, and statistics concerning, among other things, the percentage of the purchaser's contracts that are awarded to such qualified suppliers. Similarly, winning qualified suppliers can be provided accurate information as to the actual dollar value of contracts that have been awarded. That is, the amount actually paid to the winning supplier, through the purchase order/invoice process, as well as processing payment through the ACH, can be reported. In this way, all interested parties can know the actual dollar amount that is being awarded to such contractors.

While specific embodiments of the invention have been shown in the drawings and described in detail, it will be appreciated by those skilled in the art that various modifications and alternatives would be developed in light of the overall teachings of the disclosure. Accordingly, the particular arrangements disclosed herein are meant to be illustrative only and not limiting as to the scope of the invention, which is to be given the full breadth of the appended claims and in any and all equivalents thereof.

1. An electronic commerce system comprising:
a host location;
means for registering suppliers of goods or services with the host location;
means for registering a purchaser of goods or services;
means for awarding a contract from the purchaser to one of said suppliers;
means for issuing an invoice from said one supplier to the purchaser such that the purchaser compensates said one supplier via the host location to provide a completed transaction; and
means for providing a report from the host location identifying the completed transaction between the purchaser and said one supplier.

2. An electronic commerce system as recited in claim 1, wherein the host site is a webpage on the worldwide web.

3. An electronic commerce system as recited in claim 1, wherein said means for awarding a contract from the purchaser to one of said suppliers comprises a reverse auction process running on the host site.

4. An electronic commerce system as recited in claim 1, wherein said means for awarding a contract from the purchaser to one of said suppliers comprises the purchaser ordering goods or services from a catalog posted on the host site by said suppliers.

5. An electronic commerce system as recited in claim 1, wherein said means for registering suppliers comprises one or more of inputting the supplier's company name, address, phone number, e-mail address, or qualification as a minority or women-owned business entity.

6. An electronic commerce system as recited in claim 5, wherein said means for providing a report comprises providing data/statistics regarding amount of contracts with a qualified supplier that the purchaser has awarded.

7. An electronic commerce system as recited in claim 2, wherein said means for awarding a contract from the purchaser to one of said suppliers comprises the purchaser ordering goods or services from a catalog posted on the host site by said suppliers.

8. An electronic commerce system as recited in claim 3, wherein said means for awarding a contract from the purchaser to one of said suppliers comprises the purchaser ordering goods or services from a catalog posted on the host site by said suppliers.

9. An electronic commerce system as recited in claim 2, wherein said means for registering suppliers comprises one or more of inputting the supplier's company name, address, phone number, e-mail address, or qualification as a minority or women-owned business entity.

10. An electronic commerce system as recited in claim 3, wherein said means for registering suppliers comprises one or more of inputting the supplier's company name, address, phone number, e-mail address, or qualification as a minority or women-owned business entity.

11. An electronic commerce system as recited in claim 4, wherein said means for registering suppliers comprises one or more of inputting the supplier's company name, address, phone number, e-mail address, or qualification as a minority or women-owned business entity.

12. An electronic commerce system as recited in claim 10, wherein said means for providing a report comprises providing data/statistics regarding amount of contracts with a qualified supplier that the purchaser has awarded.

13. An electronic commerce system as recited in claim 11, wherein said means for providing a report comprises providing data/statistics regarding amount of contracts with a qualified supplier that the purchaser has awarded.

14. An electronic commerce system as recited in claim 9, wherein said means for providing a report comprises providing data/statistics regarding amount of contracts with a qualified supplier that the purchaser has awarded.

15. An electronic commerce system as recited in claim 2, wherein said means for awarding a contract from the purchaser to one of said suppliers comprises a reverse auction process running on the host site.

16. An electronic commerce system comprising:
a host location;
means for registering suppliers of goods or services with the host location;
means for registering a purchaser of goods or services, wherein the purchaser establishes/issues minimum terms for purchasing said goods or services within the host location;
means for said suppliers to submit bids to the purchaser to provide said goods or services to the purchaser;
means for awarding a contract/purchaser order from the purchaser to a winning supplier;
means for issuing an invoice from the winning supplier to the purchaser such that the purchaser compensates the winning supplier via the host location to provide a completed transaction; and
means for providing a report from the host location identifying the completed transaction between the purchaser and the winning supplier.

17. An electronic commerce system as recited in claim 16, wherein the host site is a webpage on the worldwide web.

18. An electronic commerce system as recited in claim 7, wherein said means for awarding a contract from the purchaser to one of said suppliers comprises a reverse auction process running on the host site.

19. An electronic commerce system as recited in claim 18, wherein said means for registering suppliers comprises one or more of inputting the supplier's company name, address, phone number, e-mail address, or qualification as a minority or women-owned business entity.

20. An electronic commerce system as recited in claim 19, wherein said means for providing a report comprises providing data/statistics regarding amount of contracts with a qualified supplier that the purchaser has awarded.

21. A method of completing a commercial transaction over a telecommunications network between a purchaser and a qualified supplier, said method comprising the steps of:
providing a host site on the telecommunications network;
registering a plurality of qualified suppliers according to a predetermined criterion with the host site;
posting a request on the host site from the purchaser for the purchase of goods/services from said plurality of qualified suppliers;
submitting bids from one or more of said plurality of qualified suppliers to the host site for supplying said goods/services to the purchaser;
the purchaser selecting a winning supplier from said plurality of qualified suppliers, the purchaser issuing a purchase order to the winning supplier through the host site;
the winning supplier performing under the purchase order;
the winning supplier issuing an invoice to the supplier through the host site;
the purchaser compensating the winning supplier via the host site; and
the host site issuing a report identifying a completed commercial transaction between the purchaser and the winning supplier.
